(19) United States
(12) Patent Application Publication
(10) Pub. No.: US 2007/0121435 A1
(43) Pub. Date: May 31, 2007

(54) Objective-lens actuator, and information recording and reproducing apparatus

(76) Inventors: Makoto Nagasato, Yokohama-Shi (JP); Kenya Kurokawa, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/605,894

(22) Filed: Nov. 29, 2006

(30) Foreign Application Priority Data
Nov. 30, 2005 (JP) 2005-345012

(51) Int. Cl. G11B 7/00

(52) U.S. Cl. 369/44.16

(57) ABSTRACT

An overhang type objective-lens actuator includes an objective lens for focusing laser light onto an optical disk, a substantially tongue-shaped lens holder formed of a magnesium alloy and having a circular opening in which the objective lens is mounted, the circular opening being provided near a front end of the lens holder, a fixed unit disposed such as to face a bottom face and a rear end face of the lens holder, a plurality of suspension wires for suspending the lens holder, the suspension wires being fixed at one end to the lens holder and at the other end to the fixed unit, a plurality of coils and a plurality of magnets for driving the lens holder in a tracking direction, a focus direction, and a tilting direction, and a plurality of damper weights bonded to an outer peripheral surface of the lens holder.

### CROSS-REFERENCE TO RELATED APPLICATIONS

This application claims the benefit of priority of Japanese Patent Application No. 2005-345012, filed Nov. 30, 2005, the entire contents of which are incorporated herein by reference.

### BACKGROUND

1. Field

The present invention relates to an objective-lens actuator and an information recording and reproducing apparatus, and more particularly, to an objective-lens actuator for driving an objective-lens in an optical pickup along three axes, and an information recording and reproducing apparatus including the actuator.

2. Description of the Related Art

In an information recording and reproducing apparatus for an optical disk, information is recorded and reproduced by precisely focusing laser light onto a specific point on the optical disk. In order to achieve precise focusing, an objective-lens actuator controls the relative positions or relative attitude angles of the optical disk and an objective-lens for focusing the laser light.

More specifically, position control called tracking control and focus control, and attitude control called radial tilt control are exerted with servo mechanisms.

Tracking control is servo control that finely adjusts the radial position of the objective lens so that laser light is constantly focused onto the center of a specific track on the optical disk. Focus control is servo control that controls the distance between the objective lens and the optical disk so that laser light is precisely focused onto the optical disk.

Radial tilt control is servo control that controls the attitude angle of the objective lens in the radial direction of the optical disk so that laser light is constantly perpendicularly applied onto a reflecting surface of the optical disk even when the reflecting surface slightly deviates from a plane perpendicular to the optical axis of the laser light and tilts in the radial direction.

The objective-lens actuator needs to follow an optical disk even when the optical disk rotates at high speed, and therefore, the servo control system is required to have high responsiveness. That is, the servo control system is required to have a wide frequency band. Also, the servo control system needs stability so as not to cause, for example, oscillation over a wide frequency band.

As generally known, in a gain characteristic of the objective-lens actuator shown by a Bode diagram, a plurality of gain peaks (hereinafter referred to as high-order gain peaks) are produced in a high-frequency region.

When high-order gain peaks are high, the objective lens heavily vibrates at a high frequency (hereinafter referred to as high-order resonance), and control becomes unstable. For this reason, it is important in design of the objective-lens actuator to suppress high-order gain peaks.

JP-A 2003-6894 discloses that high-order gain peaks can be decreased and a large gain margin for high-order resonance can be ensured by bonding damper weights to driving coils for tracking control and focus control.

In recent objective-lens actuators, structures for fixedly supporting an objective lens (hereinafter referred to as lens holders) can be classified by shape into two types, namely, a lens center type and an overhang type.

In a lens holder of a lens center type, an objective lens is located almost at the center of a rectangular frame. For example, a lens holder of an objective-lens actuator disclosed in the above-described publication is of a lens center type.

In the lens center type lens holder, an optical system for guiding laser light to the objective lens must be placed directly below the lens holder, and this limits thickness reduction of the optical pickup. On the other hand, since the lens holder is basically formed of a rectangular frame, it is resistant to elastic deformation. Therefore, the lens holder is relatively advantageous in high-order resonance.

In contrast, in a lens holder of an overhang type, an objective lens is located near the leading end of a frame shaped like a tongue whose thickness decreases in a tapered manner.

Since the objective lens directly overhangs the optical system in the overhang type lens holder, the thickness of the optical pickup can be reduced considerably. On the other hand, in respect of structure, this lens holder is less resistant to elastic deformation than the lens center type lens holder, and is somewhat disadvantageous in high-order resonance.

In recent years, there is an increasing demand to decrease the thickness of notebook personal computers. In order to meet this demand for thickness reduction, it is essential to reduce the thickness of an optical disk drive. For that purpose, an overhang type lens holder has frequently been used in objective-lens actuators. Owing to these circumstances, there is a strong demand to take countermeasures against high-order resonance for an overhang type lens holder that has a structure somewhat disadvantageous in high-order resonance.

Further, optical disks having a high recording density, such as HD DVDs, have recently been in practical use. Since these high-density optical disks are rotated at a speed higher than before, it is necessary to broaden the frequency band of the objective-lens actuator.

In order to broaden the frequency band, for example, it is effective to form the lens holder of a magnesium alloy, instead of synthetic resin which has been used, so that the rigidity of the lens holder is increased and the frequency region, where high-order gain peaks are produced, is shifted to a higher frequency region.

However, even if the region where high-order gain peaks are produced is shifted to a higher region by using a magnesium alloy, it remains important to decrease the magnitude of the high-order gain peaks themselves.

The technique using damper weights disclosed in the above-described publication JP-A 2003-6894 is effective in reducing high-order gain peaks. However, this technique is applied only to the lens holder of a lens center type, but is not applicable to an overhang type lens holder that is dominantly used in recent thin objective-lens actuators.

### SUMMARY OF THE INVENTION

The present invention has been made in view of the above-described circumstances, and an object of the invention is to provide an objective-lens actuator that includes an overhang type lens holder and that can effectively suppress high-order resonance by a simple means, and an information recording and reproducing apparatus including the actuator.

In order to overcome the above-described problems, an overhang type objective-lens actuator according to an aspect of the present invention includes an objective lens for focusing laser light onto an optical disk; a substantially tongue-shaped lens holder formed of a magnesium alloy and having a circular opening in which the objective lens is mounted, the circular opening being provided near a front end of the lens holder; a fixed unit disposed such as to face a bottom face and a rear end face of the lens holder; a plurality of suspension wires for suspending the lens holder, the suspension wires being fixed at one end to the lens holder and at the other end to the fixed unit; a plurality of coils and a plurality of magnets for driving the lens holder in a tracking direction, a focus direction, and a tilting direction; and a plurality of damper weights bonded to an outer peripheral surface of the lens holder.

An information recording and reproducing apparatus according to another aspect of the present invention includes an optical pickup having an overhang type objective-lens actuator; a driving control unit for controlling the driving of the objective-lens actuator; a demodulation unit for demodulating an optical-disk reproduction signal output from the optical pickup; and a modulation unit for modulating recording data and outputting the recording data as a laser control signal to the optical pickup. The objective-lens actuator includes an objective lens for focusing laser light onto an optical disk; a substantially tongue-shaped lens holder formed of a magnesium alloy and having a circular opening in which the objective lens is mounted, the circular opening being provided near a front end of the lens holder; a fixed unit disposed such as to face a bottom face and a rear end face of the lens holder; a plurality of suspension wires for suspending the lens holder, the suspension wires being fixed at one end to the lens holder and at the other end to the fixed unit; a plurality of coils and a plurality of magnets for driving the lens holder in a tracking direction, a focus direction, and a tilting direction; and a plurality of damper weights bonded to an outer peripheral surface of the lens holder.

The objective-lens actuator having the overhang type lens holder and the information recording and reproducing apparatus including the objective-lens actuator according to the above aspects of the invention can effectively suppress high-order resonance by a simple means.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of an information recording and reproducing apparatus according to an embodiment of the present invention;

FIG. 2 is an external perspective view showing the overall configuration of an objective-lens actuator;

FIG. 3 is an external perspective view showing the overall configuration of the objective lens actuator in which an upper yoke is not provided;

FIG. 4 is an external perspective view showing the structure of a moving unit in the objective-lens actuator in which damper weights are not provided;

FIG. 5 is an external perspective view of a lens holder in the moving unit in which the damper weights are not provided;

FIG. 6 is an external perspective view showing the structure of a fixed unit in the objective-lens actuator;

FIG. 7 is an exploded perspective view of the fixed unit;

FIG. 8 is a Bode diagram schematically showing a typical loop gain characteristic of the objective-lens actuator;

FIGS. 9A and 9B are side views showing the result of a computer simulation analysis performed on elastic deformation of the moving unit due to second-order resonance in the focus control direction;

FIGS. 10A and 10B are front views showing the result of a computer simulation analysis performed on elastic deformation of the moving unit due to third-order resonance in the focus control direction;

FIGS. 11A and 11B are plan views showing the result of a computer simulation analysis performed on elastic deformation of the moving unit due to third-order resonance in the tracking control direction;

FIG. 12 is an external perspective view showing the positions of damper weights in a moving unit according to a first embodiment;

FIG. 13 is an external perspective view showing the positions of damper weights in a moving unit according to a second embodiment;

FIG. 14 is an external perspective view showing the positions of damper weights in a moving unit according to a third embodiment;

FIG. 15 is an external perspective view showing the positions of damper weights in a moving unit according to a fourth embodiment;

FIG. 16 is an external perspective view showing the positions of damper weights in a moving unit according to a fifth embodiment;

FIG. 17 is an external perspective view showing the positions of damper weights in a moving unit according to a sixth embodiment; and

FIG. 18 is a diagram showing the result of an effect confirmation test conducted while damper weights are bonded to the rear end of the moving unit.

### DETAILED DESCRIPTION

An objective-lens actuator and an information recording and reproducing apparatus according to embodiments of the present invention will be described with reference to the attached drawings.

1. Configuration and Operation of Information Recording and Reproducing Apparatus

An information recording and reproducing apparatus 100 according to an embodiment of the present invention records and reproduces information onto and from an optical disk 200 such as a CD-R, a CR-RW, a DVD-R, a DVD-RW, a DVD-RAM, a HD DVD-ROM, a HD DVD-R, a HD DVD-RR, or a HD DVD-RAM.

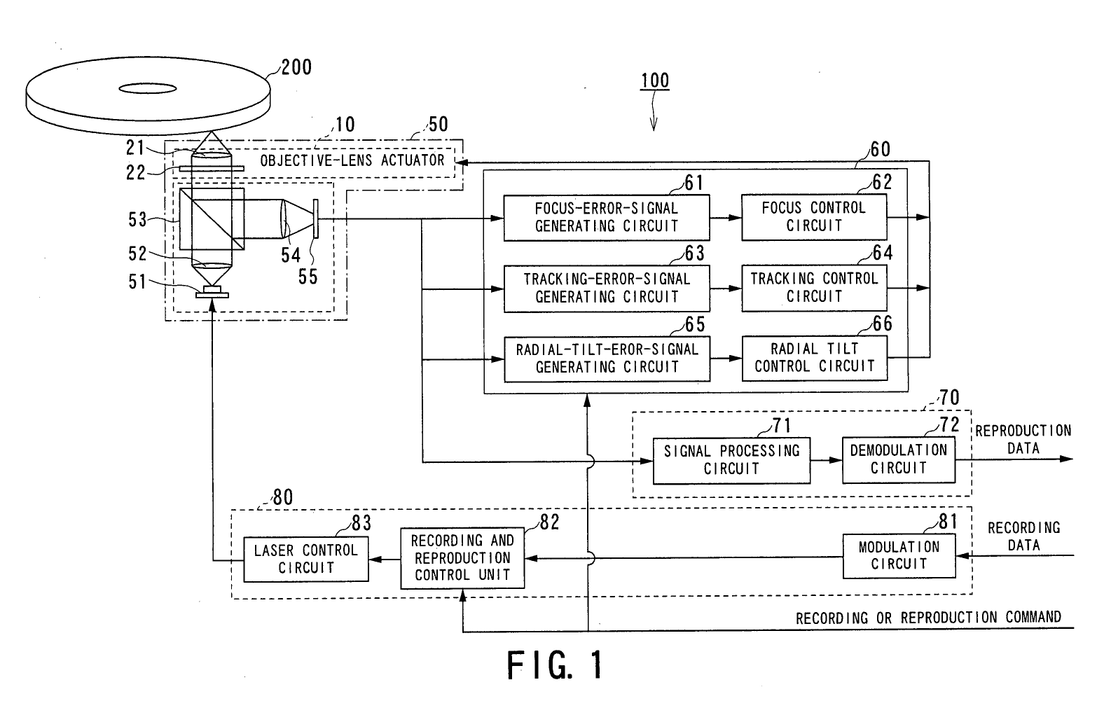

FIG. 1 shows the configuration of the information recording and reproducing apparatus 100.

The information recording and reproducing apparatus 100 includes an optical pickup 50, a three-axis control unit (driving control unit) 60, a reproduction processing unit 70, and a recording processing unit 80.

The optical pickup 50 applies laser light onto the optical disk 200 for information recording and reproduction, converts reflected light from the optical disk 200 into electrical signals, and outputs the electrical signals as reproduction signals. The optical pickup 50 includes a semiconductor laser 51, a collimator lens 52, a PBS (polarization beam splitter) 53, a quarter-wave plate 22, an objective lens 21, a light-collecting lens 54, and a photodetector 55 as constituents of an optical system.

The optical pickup 50 also includes an objective-lens actuator 10 in which the objective lens 21 and the quarter-wave plate 22 are mounted. The objective-lens actuator 10 exerts three-axis control on the objective lens 21 and the quarter-wave plate 22.

The three-axis control unit 60 includes a focus-error-signal generating circuit 61, a focus control circuit 62, a tracking-error-signal generating circuit 63, a tracking control circuit 64, a radial-tilt-error-signal generating circuit 65, and a radial tilt control circuit 66.

Control signals generated by these circuits in the three-axis control unit 60 are output to the objective-lens actuator 10 so as to exert servo control on the position and attitude angle of the objective lens 21. More specifically, focus control is exerted to control the distance between the objective lens 21 and the optical disk 200 so that laser light is precisely focused onto the optical disk 200, tracking control is exerted to finely adjust the radial position of the objective lens 21 so that laser light is constantly focused onto the center of a specific track on the optical disk 200, and radial tilt control is exerted to control the attitude angle of the objective lens 21 in the radial direction of the optical disk 200 so that laser light is constantly perpendicularly applied onto a reflecting surface of the optical disk 200 even when the optical disk 200 slightly deviates from the horizontal position and tilts in the radial direction.

The reproduction processing unit 70 performs reproduction processing on a signal output from the optical pickup 50, and includes a signal processing circuit 71 and a demodulation circuit 72.

The recording processing unit 80 mainly records information on the optical disk 200, and includes a modulation circuit 81, a recording and reproduction control unit 82, and a laser control circuit 83.

A description will be given of the operation of the information recording and reproducing apparatus 100 having the above-described configuration. First, an operation of recording information on the optical disk 200 will be described.

The modulation circuit 81 of the recording processing unit 80 modulates recording information (data symbols) supplied from a host, such as a main unit of a personal computer, into a channel bit stream in a predetermined modulation method. The channel bit stream corresponding to the recording information is input to the recording and reproduction control unit 82.

A recording or reproduction command (in this case, a recording command) is input from the host to the recording and reproduction control unit 82. Then, the recording and reproduction control unit 82 outputs a control signal to the three-axis control unit 60, thereby driving the objective-lens actuator 10 so that a laser beam is properly focused onto a target recording position. Further, the recording and reproduction control unit 82 supplies the channel bit stream to the laser control circuit 83.

The laser control circuit 83 converts the channel bit stream into a laser driving waveform, and thereby drives the semiconductor laser 51 in a pulsed manner. As a result, the semiconductor laser 51 generates a recording light beam corresponding to the supplied channel bit stream.

The recording light beam generated by the semiconductor laser 51 is collimated by the collimator lens 52, and passes through the PBS 53. After passing through the PBS 53, the light beam passes through the quarter-wave plate 22, and is focused onto an information recording surface of the optical disk 200 by the objective lens 21.

The focused recording light beam is maintained in a state such as the best light beam spot can be obtained on the information recording surface of the optical disk 200, under focus control, tracking control, and radial tilt control of the three-axis control unit 60 and the objective-lens actuator 10.

A description will now be given of reproduction of information from the optical disk 200 by the information recording and reproducing apparatus 100.

A recording or reproduction command (in this case, a reproduction command) is input from the host to the recording and reproduction control unit 82. The recording and reproduction control unit 82 outputs a reproduction control signal to the laser control circuit 83 according to the reproduction command from the host.

The laser control circuit 83 drives the semiconductor laser 51 according to the reproduction control signal so as to generate a reproduction light beam. The reproduction light beam generated by the semiconductor laser 51 is collimated by the collimator lens 52, and passes through the PBS 53. After passing through the PBS 53, the light beam passes through the quarter-wave plate 22, and is focused onto the information recording surface of the optical disk 200 by the objective lens 21.

The focused reproduction light beam is maintained in a state such as the best light beam spot can be obtained on the information recording surface of the optical disk 200, under focus control, tracking control, and radial tilt control of the three-axis control unit 60 and the objective-lens actuator 10.

The reproduction light beam applied onto the optical disk 200 is reflected by a reflecting film or a reflective recording film in the information recording surface. The reflected light passes through the objective lens 21 in an opposite direction, is collimated again, passes through the quarter-wave plate 22, and is reflected by the PBS 53 that provides polarization perpendicular to the incident light.

The light beam reflected by the PBS 53 is converted into convergent light by the light-collecting lens 54, and enters the photodetector 55. The photodetector 55 is, for example, a four-split photodetector. The light beam incident on the photodetector 55 is photoelectrically converted into electrical signals, and is amplified. The amplified signals are equalized and binarized by the signal processing circuit 71 of the reproduction processing unit 70, and are sent to the demodulation circuit 72. The demodulation circuit 72 demodulates the signals in a manner corresponding to a predetermined modulation manner, and thereby outputs reproduction data.

On the other hand, the electrical signals output from the photodetector 55 are partly input to the three-axis control unit 60, and a focus error signal is generated by the focus-error-signal generating circuit 61. Similarly, the electric signals output from the photodetector 55 are partly input to the three-axis control unit 60, and a tracking error signal and a radial tilt error signal are generated by the tracking-error-signal generating circuit 63 and the radial-tilt-error-signal generating circuit 65, respectively.

The focus control circuit 62 controls the objective-lens actuator 10 according to the focus error signal, and thereby controls focusing of the beam spot. The tracking control circuit 64 controls the objective-lens actuator 10 according to the tracking error signal, and thereby controls tracking of the beam spot. The radial tilt control circuit 66 controls the objective-lens actuator 10 according to the radial tilt error signal, and thereby controls radial tilting of the beam spot.

In this way, the objective-lens actuator 10 controls the position and attitude angle of the objective lens 21 mounted therein according to the control signals from the three-axis control unit 60, and maintains the beam spot on the best position on the optical disk 200.

The configuration and operation of the objective-lens actuator 10 will be described below.

2. Configuration of Objective-Lens Actuator

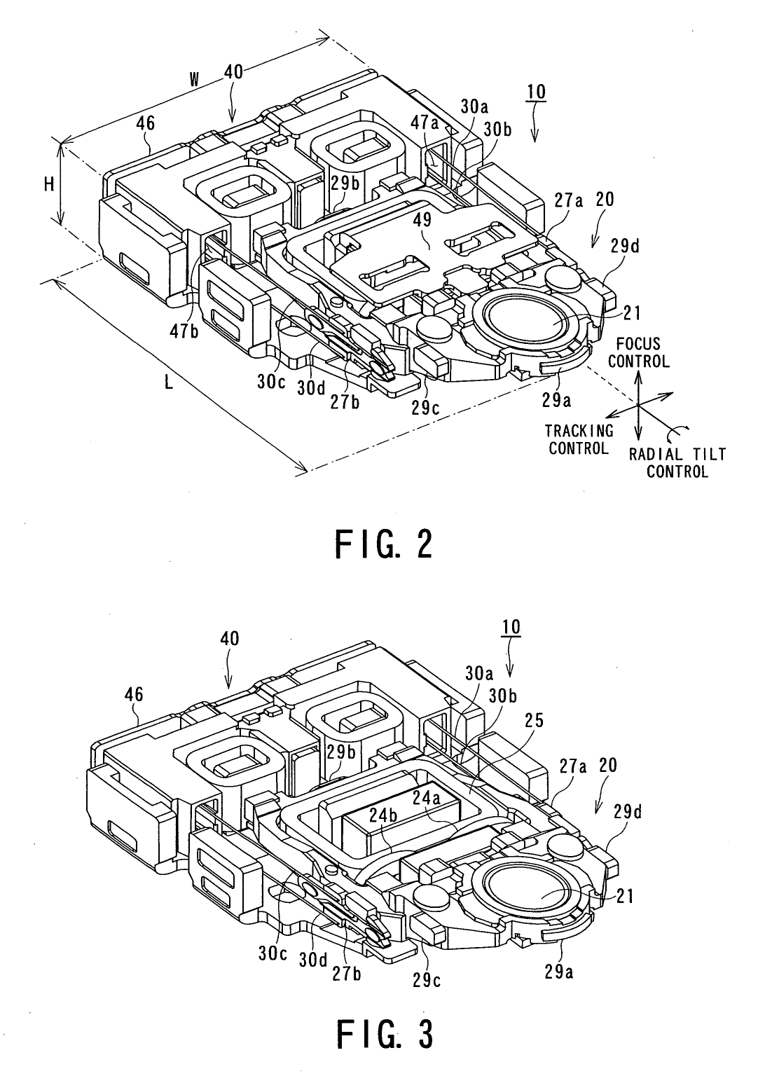

FIG. 2 is an external perspective view showing the overall configuration of the objective-lens actuator 10. The objective-lens actuator 10 is generally shaped almost like a tongue. The objective-lens actuator 10 has a circular opening at its front end, and the objective lens 21 is mounted in the opening.

The objective-lens actuator 10 is installed in the optical pickup 50 such that the objective lens 21 faces the reflecting surface of the optical disk 200. The objective-lens actuator 10 is quite small, and, for example, has a height H of approximately 6.5 mm, a width W of approximately 13.5 mm, and a length L of approximately 16 mm.

In FIG. 2, an optical system (not shown) including the PBS 53 and so on is provided on the lower side of the objective lens 21. Since the front end of the objective-lens actuator 10 overhangs a part of the optical system, the objective-lens actuator 10 shown in FIG. 2 is called an overhanging actuator.

The objective-lens actuator 10 generally includes a moving unit 20, a fixed unit 40, and suspension wires 30a, 30b, 30c, and 30d.

In this embodiment, the suspension wires 30a, 30b, 30c, and 30d (hereinafter, generically referred to suspension wires 30) are formed of four elastic wires, and are fixed at one end to the moving unit 20 and at the other end to the fixed unit 40. The moving unit 20 is suspended relative to the fixed unit 40 by these suspension wires 30.

The suspension wires 30 also function as conductors that supply electric current to tracking control coils 24a and 24b and a focus control coil 25 (these coils will be described below) mounted in the moving unit 20.

The suspension wires 30 are fixed to moving-unit substrates 27a and 27b provided on both sides of the moving unit 20, for example, by soldering.

On the other hand, the suspension wires 30 extend through rectangular through holes 47a and 47b provided on both rear sides of the fixed unit 40, and are fixed to a fixed-unit substrate 46 provided at the rear end of the fixed unit 40, for example, by soldering.

The through holes 47a and 47b are filled with, for example, a UV-curing gel agent. A vibration peak value of the moving unit 20 (mainly, a peak value of vibration due to main resonance) is reduced by a damping effect of the gel agent.

A plurality of damper weights 29 (29a, 29b, 29c, and 29d) are provided on an outer peripheral surface of the moving unit 20 so as to suppress high-order resonance of the moving unit 20. The mounting positions and operation of the damper weights 29 will be specifically described below.

FIG. 3 is an external perspective view of the objective-lens actuator 10 from which an upper yoke 49 serving as a constituent of the fixed unit 40 is removed so that the structure of the moving unit 20 can be seen more easily. Below the upper yoke 49, the tracking control coils 24a and 24b and the focus control coil 25 are disposed, and are fixed to the moving unit 20.

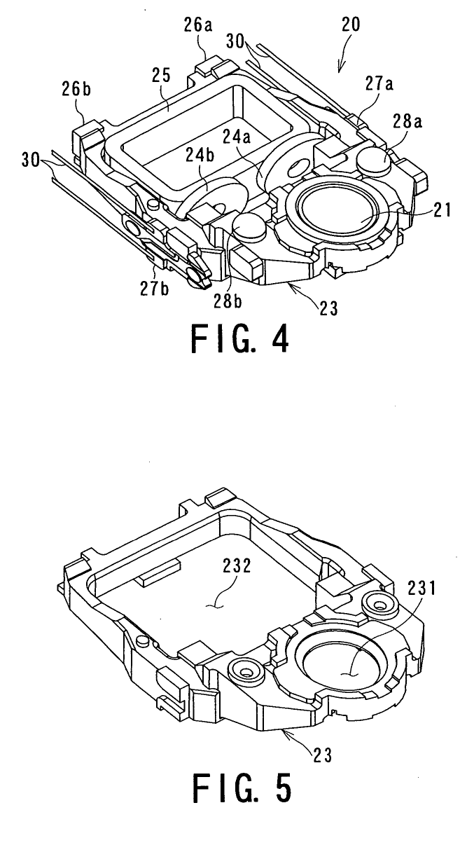

FIG. 4 shows only the moving unit 20 in the objective-lens actuator 10. The moving unit 20 includes a lens holder 23 functioning as a structural member of the moving unit 20. The objective lens 21, the tracking coils 24a and 24b, the focus control coil 25, and a pair of radial tilt control magnets 26a and 26b are fixed to the lens holder 23. The moving-unit substrates 27a and 27b are also fixed to both sides of the lens holder 23.

A pair of collision relaxation members 28a and 28b are provided on an upper surface of the lens holder 23 on both sides of the objective lens 21, and prevent the optical disk 200 from being damaged even if the moving unit 20 operates abnormally.

As described above, the moving unit 20 itself is suspended by the suspension wires 30, and therefore, a frictional force is not produced during driving under the tracking control, the focus control, and the radial tilt control.

Tracking control is exerted by controlling an electromagnetic force produced by a current flowing through the tracking control coils 24a and 24b and a magnetic flux of a tracking control magnet 42 (a constituent of the fixed unit 40) disposed adjacent to the tracking control coils 24a and 24b.

Similarly, focus control is exerted by controlling an electromagnetic force produced by a current flowing through the focus control coil 25 and a magnetic flux of a focus control magnet 43 (a constituent of the fixed unit 40) extending through the center of the focus control coil 25.

Further, radial tilt control is exerted by controlling an electromagnetic force produced by a magnetic flux of the radial tilt control magnets 26a and 26b fixed to the rear of the moving unit 20 and a current flowing through radial tilt control coils 44a and 44b (constituents of the fixed unit 40).

Tracking control, focus control, and radial tilt control achieve a small amount of shift, and, for example, are exerted with a precision of several micrometers or less.

FIG. 5 is an external perspective view of the lens holder 23. The lens holder 23 has a circular opening 231 at its front end, and the objective lens 21 is mounted in the opening 231. The lens holder 23 also has a rectangular opening 232 at its center, and the tracking control coils 24a and 24b and the focus control coil 25 are fixed to the inner periphery of the opening 232.

While the lens holder 23 shifts by a small amount, it is required to properly follow the optical disk 200 that rotates at high speed. Therefore, the lens holder 23 needs to be formed of a material having a light weight and a high Young's modulus (high rigidity). For this reason, most conventional lens holders have been formed of engineering plastic having a light weight and a high rigidity, for example, a liquid crystal polymer.

However, recent high-density recording media, such as HD DVDs, have been required to have responsiveness higher than that of conventional DVDs. For this reason, there is a demand to increase the rigidity of the material of the lens holder while maintaining a light weight. Therefore, it is preferable that the lens holder 23 be formed of a magnesium alloy as an example. In this embodiment, the lens holder 23 is formed of a magnesium alloy.

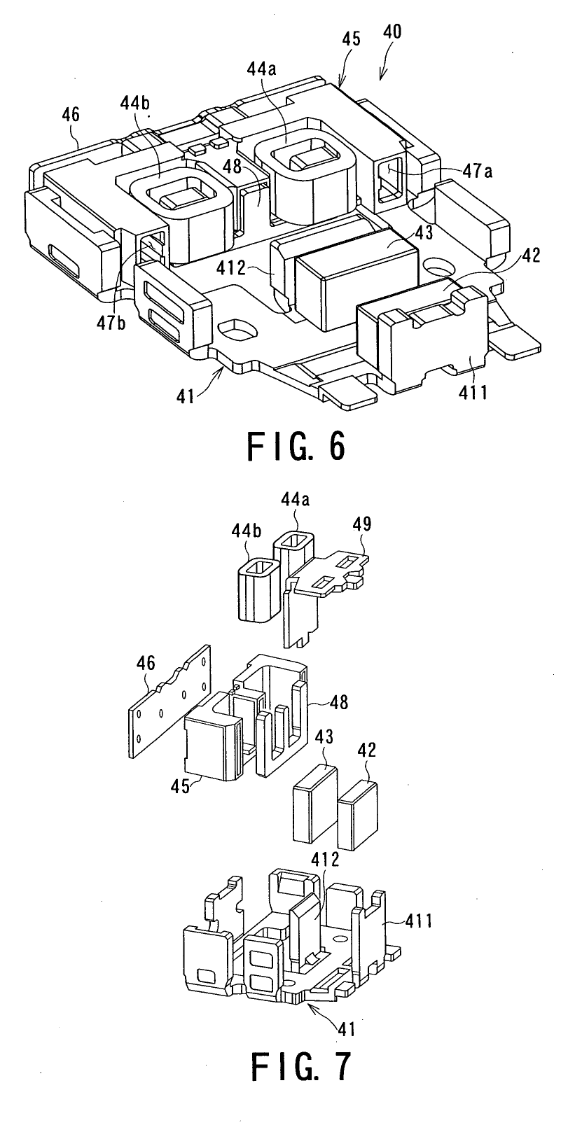

FIG. 6 is an external perspective view showing the structure of the fixed unit 40 in the objective-lens actuator 10. FIG. 7 is an exploded perspective view of the fixed unit 40.

The fixed unit 40 includes a base yoke 41, the focus/tracking control magnets 42 and 43, a main unit 45, a back yoke 48, the fixed-unit substrate 46, the radial tilt control coils 44a and 44b, and the upper yoke 49 (not shown in FIG. 6).

The base yoke 41 functions as a lower structural member of the fixed unit 40, and forms a part of a magnetic circuit.

The focus/tracking control magnet 42 is fixed to an extension plate 411 extending upward and vertically from the base yoke 41. The focus/tracking control magnet 43 is fixed to an extension plate (see FIG. 7) extending downward and vertically from the upper yoke 49. Focus control and tracking control are exerted on the moving unit 20 by a electromagnetic force produced between magnetic fluxes generated by these two magnets and currents flowing through the focus control coil 25 and the tracking control coils 24a and 24b.

The main unit 45 provided on the rear side of the fixed unit 40 has the rectangular through holes 47a and 47b on both sides thereof. The suspension wires 30 extend through the through holes 47a and 47b, and are fixed to the fixed-unit substrate 46 at the rear of the main unit 45 by soldering or by other means. A control current is supplied from the fixed-unit substrate 46 to the focus control coil 25 and the tracking control coils 24a and 24b via the suspension wires 30.

The back yoke 48 is placed in a recess provided in the main unit 45. The radial tilt control coils 44a and 44b for generating a driving force for radial tilt control in the magnets 26a and 26b are placed in extending portions at both ends of the back yoke 48.

The upper yoke 49 is disposed to cover the focus/tracking control magnets 42 and 43, and forms a part of the magnetic circuit.

3. Operation of Objective-Lens Actuator

A description will be given of the operation of the objective-lens actuator 10 having the above-described configuration. In particular, the description will be focused on high-order resonance during a servo control operation of the objective-lens actuator 10.

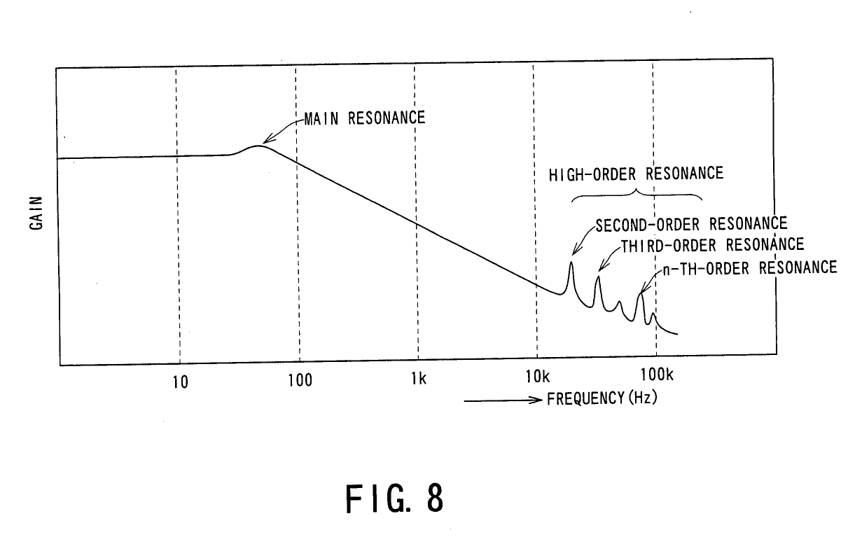

FIG. 8 is a Bode diagram schematically showing a typical loop gain characteristic of the objective-lens actuator 10. In general, the loop gain characteristic of the objective-lens actuator 10 includes a gentle peak (main resonance) shown in a region of 100 Hz or less and a plurality of gain peaks (high-order resonance) shown in a region of 10 kHz or more.

Main resonance corresponds to a mode in which the moving unit 20 of the objective-lens actuator 10 resonates without being deformed elastically. In contrast, high-order resonance corresponds to resonance accompanied by elastic deformation of the moving unit 20, particularly, of the lens holder 23. High-order resonance includes second-order resonance, third-order resonance, etc. in order of increasing frequency.

When the objective-lens actuator 10 is driven, the objective lens 21 sometimes heavily vibrates in a frequency region of several tens of kilohertz, and this makes control unstable. This is because the lens holder 23 resonates and elastically deforms since a vibration frequency component reaches the natural frequency of the lens holder 23.

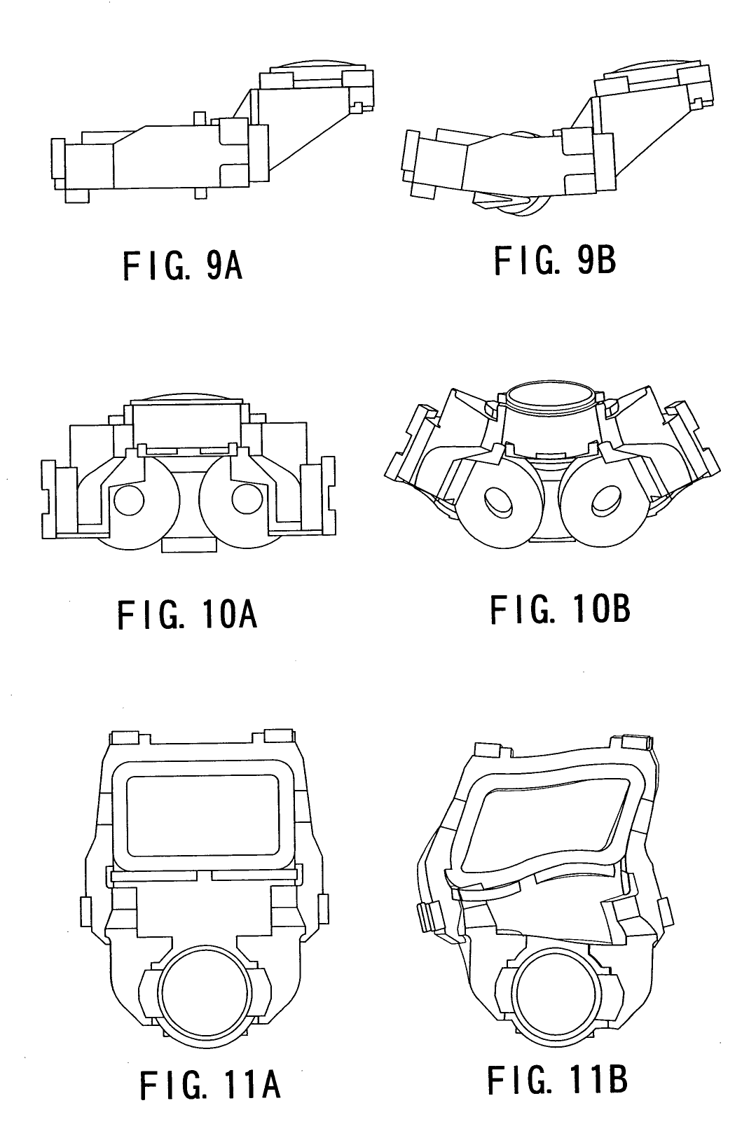

FIGS. 9A and 9B are side views showing the result of a computer simulation analysis performed on elastic deformation of the moving unit 20 due to second-order resonance in the focus control direction.

FIG. 9A shows a state before vibration and FIG. 9B shows a state during second-order resonance. As shown in these figures, the lens holder 23 is elastically deformed by second-order resonance in the focus control direction, and particularly, the rear and the front (where the objective lens 21 is mounted) of the moving unit 20 are markedly curved and deformed in the vertical direction.

FIGS. 10A and 10B are front views showing the result of a computer simulation analysis similarly performed on elastic deformation of the moving unit 20 due to third-order resonance in the focus control direction (the moving unit 20 is viewed from the front side of the objective lens 21).

FIG. 10A shows a state before vibration, and FIG. 10B shows a state during third-order resonance. While the front and rear of the moving unit 20 are vertically curved and deformed during second-order resonance, both sides of the moving unit 20 are vertically curved and deformed during third-order resonance.

FIGS. 11A and 11B are plan views similarly showing the result of a computer simulation analysis similarly performed on elastic deformation of the moving unit 20 due to third-order resonance in the tracking control direction (the moving unit 20 is viewed from above).

FIG. 11A shows a state before vibration, and FIG. 11B shows a state during third-order resonance in the tracking control direction. During third-order resonance in the tracking control direction, the moving 20 is elastically deformed in a manner such as to twist horizontally. As a result, a lateral displacement occurs at the front end (near the objective lens 21) and the rear end of the moving unit 20 as if the moving unit 20 rotated, as viewed from above.

In recording and reproduction of the optical disk 200, particularly, resonance up to approximately 50 kHz causes a problem. High-speed recording and reproduction are necessary for high-density recording media such as HD DVDs. For that purpose, it is important to widen the control band of the servo system, compared with the conventional DVDs. Therefore, it is necessary to shift the frequency region, where high-order resonance occurs, to a higher region, or to decrease the gain peak value of high-order resonance.

As a means for shifting the frequency region to a higher region, that is, a means for increasing the natural frequency of the lens holder 23, it is conceivable to form the lens holder 23 of a material having a high flexural rigidity. For this reason, in this embodiment, the lens holder 23 is formed of a magnesium alloy, as described above.

However, when a material having a still higher flexural rigidity, that is, a material having a high specific gravity is used, the weight of the moving unit 21 in the objective-lens actuator 10 increases, and the driving sensitivity decreases.

It is also conceivable to optimize the shape of the lens holder 23 so as to ensure a high flexural rigidity. In this embodiment, however, an overhanging structure is adopted such that the constituents of the optical system can be stored below the objective lens 21 in order to reduce the thickness. For this reason, there is a limit to reinforcing a part of the lens holder 23 near the objective lens 21. Depending on the shape optimized to increase the flexural rigidity, it is difficult to increase the natural frequency.

Accordingly, the gain peak value of high-order resonance is reduced in this embodiment. More specifically, the gain peak value of high-order resonance is reduced by bonding damper weights 29 to the outer periphery of the lens holder 23.

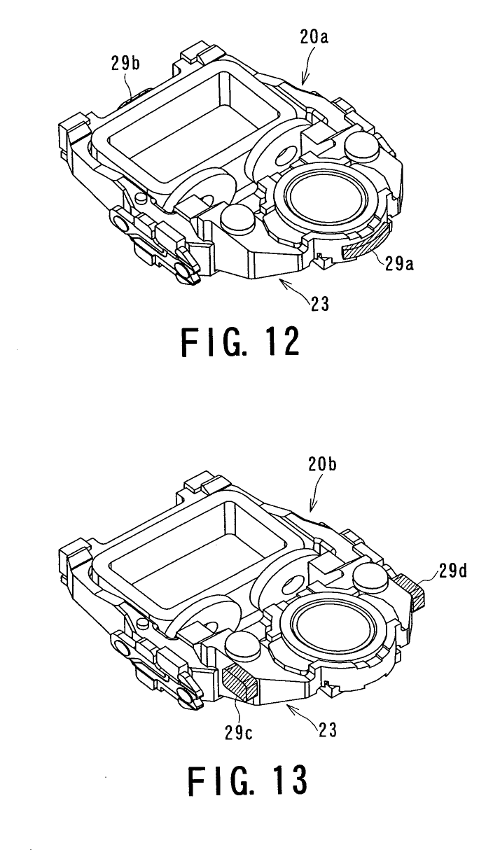

FIG. 12 is an external view of a moving unit 20a according to a first embodiment in which a damper weight 29a and a damper weight 29b are bonded to the front and rear ends of the lens holder 23, respectively.

The damper weights 29a and 29b (hereinafter generically referred to as damper weights 29) are bonded to the outer periphery of the lens holder 23 with a highly viscous adhesive. By this viscous bonding, the damper weights 29 become other vibrators connected to the moving unit 20a by a spring-dashpot system. As a result, even when the moving unit 20a resonates and the objective lens 21 heavily vibrates, the damper weights 29 are spring-connected, and vibrate with a slight phase shift. This can absorb the vibration energy of the objective lens 21 and can reduce the resonance peak gain of the objective lens 21.

The damper weights 29 are formed of metal, and have a certain mass. However, the mass of one damper weight is small, for example, is approximately 2.5 mg. The ratio of the sum of masses of the damper weights 29 to the total mass of the moving unit 20a is within the range of 3% to 15%, and this has little influence on the driving sensitivity of the objective-lens actuator 10.

It is effective to bond the damper weights 29 to positions such that the vibration displacement of the lens holder 23 is the largest.

As shown by the simulation result in FIGS. 9A and 9B, the front and rear ends of the moving unit 20 are markedly displaced in the vertical direction by second-order resonance in the focus control direction. Further, as shown by the simulation result in FIGS. 11A and 11B, the front and rear ends of the moving unit 20 are displaced in the lateral direction by third-order resonance in the tracking control direction.

Since the damper weights 29a and 29b are bonded to the front and rear ends of the moving unit 20a in the first embodiment, the peak gain due to second-order resonance in the focus control direction and third-order resonance in the tracking control direction can be reduced effectively.

FIG. 13 is an external view of a moving unit 20b according to a second embodiment in which damper weights 29c and 29d are provided on the axis of the objective lens 21 in the tracking control direction and on both sides of the objective lens 21.

The simulation result shown in FIGS. 10A and 10B reveals that both sides of the moving unit 20 are markedly displaced by third-order resonance in the focus control direction.

Since the damper weights 29c and 29d are bonded to both sides (portions between which the objective lens 21 is sandwiched) of the moving unit 20b in the second embodiment, the peak gain due to third-order resonance in the focus control direction can be reduced effectively.

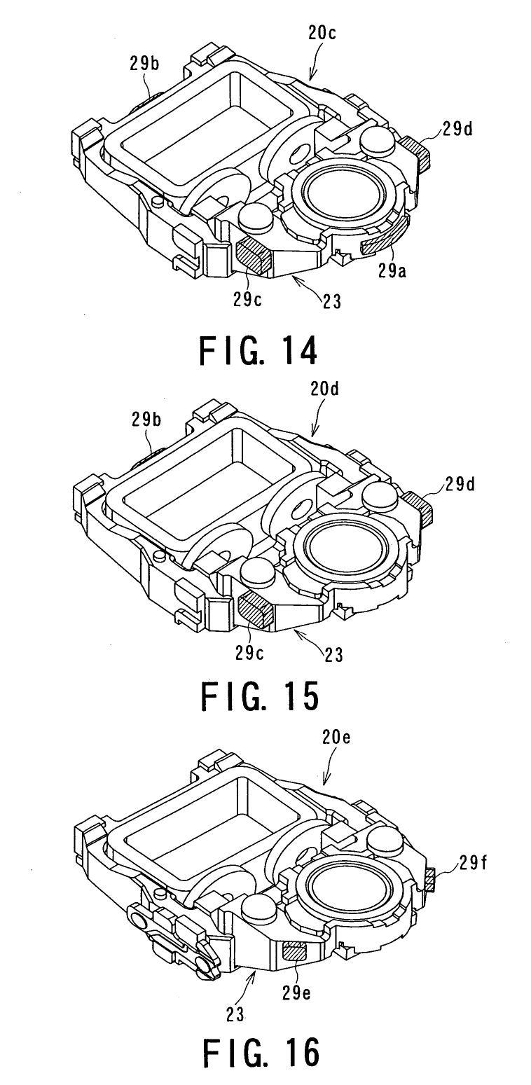

FIG. 14 is an external view of a moving unit 20c according to a third embodiment. The third embodiment is a combination of the first and second embodiments, that is, damper weights 29a and 29b are respectively bonded to the front and rear ends of the moving unit 20c, and damper weights 29c and 29d are respectively bonded at the objective lens 21.

In the third embodiment, it is possible to effectively reduce the peak gain due to second-order resonance and third-order resonance in the focus control direction and third-order resonance in the tracking control direction.

While four damper weights 29 are used in the third embodiment, the ratio of the sum of masses of the damper weights 29 to the total mass of the moving unit 20c is within the range of 3% to 15%. This has little influence on the driving sensitivity.

FIG. 15 is an external view of a moving unit 20d according to a fourth embodiment. In the fourth embodiment, the damper weight 29a is removed from the front end of the moving unit 20c in the third embodiment. That is, three damper weights 29b, 29c, and 29d are provided.

The damper weights 29c and 29d are provided near the right and left sides of the objective lens 21 and near the front end of the moving unit 20d. These two damper weights 29c and 29d also serve the function of the damper weight 29a.

FIG. 16 is an external view of a moving unit 20e according to a fifth embodiment. In the fifth embodiment, a pair of damper weights 29e and 29f are provided between the axis extending near the objective lens 21 in the tracking control direction and the front end of a lens holder 23.

In the fifth embodiment, the damper weights 29e and 29f are provided in the midpoints among the three damper weights 29c, 29d, and 29a in the third embodiment (FIG. 14). For this reason, second-order resonance and third-order resonance in the focus control direction can be simultaneously reduced by a smaller number of damper weights 29, although the effect is less than that of the third embodiment.

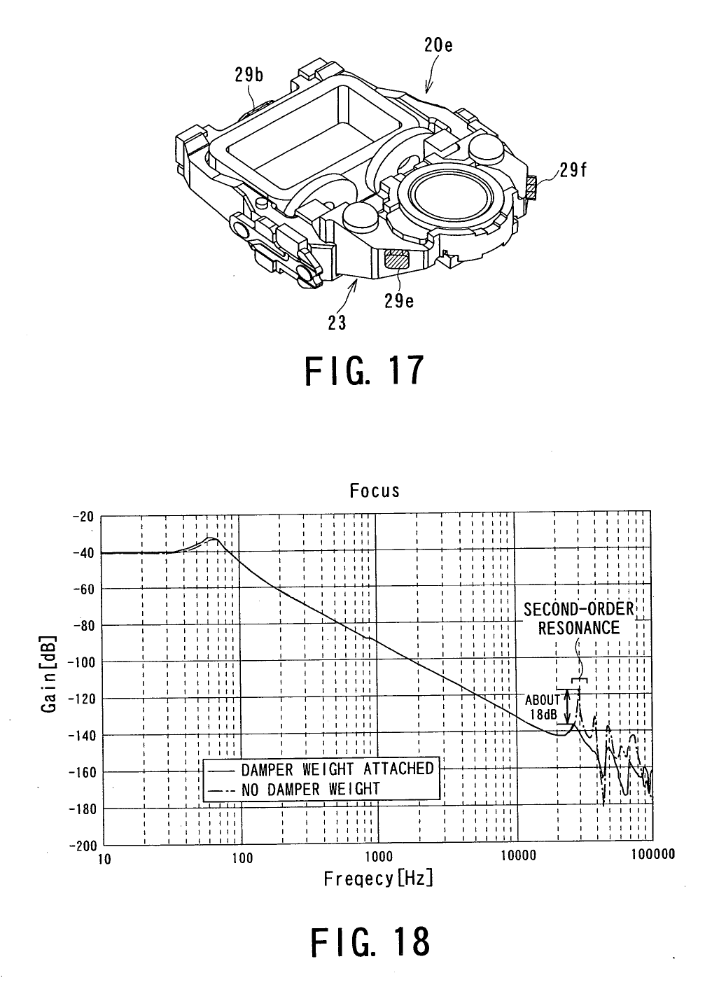

FIG. 17 is an external view of a moving unit 20f according to a sixth embodiment. In the moving unit 20f of the sixth embodiment, a damper weight 29b is added to the rear end of the moving unit 20e of the fifth embodiment. This can make second-order resonance in the focus control direction less than in the fifth embodiment.

In any of the above-described embodiments, it is preferable that the damper weights 29 be formed of a nonmagnetic material such as brass. This is because the influence on the magnetic circuit included in the objective-lens actuator 10 can be removed by forming the damper weights 29 of a nonmagnetic material.

FIG. 18 shows an example of a result of a test conducted to confirm the effect of the damper weights 29. In this test, the dampers weights 29b, 29c, and 29d were bonded to the moving unit 20.

FIG. 18 is a Bode diagram showing the loop gain characteristics in the focus control direction. In this diagram, a line showing the loop gain characteristic obtained when no damper weight 29 is provided overlaps with a line showing the loop gain characteristic obtained when damper weights 29 (damper weights 29b, 29c, and 29d) are provided.

According to the test result, the gain peak value of second-resonance in the focus control direction was reduced by approximately 18 dB by the addition of the damper weights 29b, 29c, and 29d.

As described above, according to the objective-lens actuator 10 of the embodiments, high-order resonance can be effectively suppressed by a simple means, and the stability of the servo control characteristic of the objective lens 21 can be enhanced.

It should be noted that the present invention is not limited to the above-described embodiments, and can be embodied by modifying the components without departing from the scope of the invention. Further, various embodiments of the inventions can be achieved by appropriately combining a plurality of components disclosed in the embodiments. For example, some of the components in the embodiments may be omitted. Moreover, the components in the different embodiments may be combined arbitrarily.

What is claimed is:

1. An overhang type objective-lens actuator comprising:
an objective lens for focusing laser light onto an optical disk;
a substantially tongue-shaped lens holder formed of a magnesium alloy and having a circular opening in which the objective lens is mounted, the circular opening being provided near a front end of the lens holder;
a fixed unit disposed such as to face a bottom face and a rear end face of the lens holder;
a plurality of suspension wires for suspending the lens holder, the suspension wires being fixed at one end to the lens holder and at the other end to the fixed unit;
a plurality of coils and a plurality of magnets for driving the lens holder in a tracking direction, a focus direction, and a tilting direction; and
a plurality of damper weights bonded to an outer peripheral surface of the lens holder.

2. The objective-lens actuator according to claim 1, wherein the damper weights include a pair of damper weights disposed on an axis extending in the tracking direction near the objective lens so as to sandwich the objective lens therebetween.

3. The objective-lens actuator according to claim 2, wherein the damper weights further include a damper weight provided on a rear end face of the lens holder.

4. The objective-lens actuator according to claim 3, wherein the damper weights further include a damper weight provided on a front end of the lens holder.

5. The objective-lens actuator according to claim 1, wherein the damper weights include a pair of damper weights disposed between an axis extending in the tracking direction near the objective lens and the front end of the objective lens holder.

6. The objective-lens actuator according to claim 5, wherein the damper weights further include a damper weight provided on a rear end face of the lens holder.

7. The objective-lens actuator according to claim 1, wherein the damper weights are bonded with a highly viscous adhesive.

8. The objective-lens actuator according to claim 1, wherein the damper weights are formed of a nonmagnetic metal.

9. The objective-lens actuator according to claim 1, wherein the ratio of the sum of weights of the damper weights to the total weight of a moving unit of the objective-lens actuator is within the range of 3% to 15%.

10. An information recording and reproducing apparatus comprising:
an optical pickup having an overhang type objective-lens actuator;
a driving control unit for controlling the driving of the objective-lens actuator;
a reproduction processing unit for subjecting a signal output from the optical pickup to reproduction processing; and
a recording processing unit for modulating recording data and outputting the modulated recording data as a laser control signal to the optical pickup,
wherein the objective-lens actuator includes:
an objective lens for focusing laser light onto an optical disk;
a substantially tongue-shaped lens holder formed of a magnesium alloy and having a circular opening in which the objective lens is mounted, the circular opening being provided near a front end of the lens holder;
a fixed unit disposed such as to face a bottom face and a rear end face of the lens holder;
a plurality of suspension wires for suspending the lens holder, the suspension wires being fixed at one end to the lens holder and at the other end to the fixed unit;
a plurality of coils and a plurality of magnets for driving the lens holder in a tracking direction, a focus direction, and a tilting direction; and
a plurality of damper weights bonded to an outer peripheral surface of the lens holder.

11. The information recording and reproducing apparatus according to claim 10, wherein the damper weights include a pair of damper weights disposed on an axis extending in the tracking direction near the objective lens so as to sandwich the objective lens therebetween.

12. The information recording and reproducing apparatus according to claim 11, wherein the damper weights further include a damper weight provided on a rear end face of the lens holder.

13. The information recording and reproducing apparatus according to claim 12, wherein the damper weights further include a damper weight provided on a front end of the lens holder.

14. The information recording and reproducing apparatus according to claim 10, wherein the damper weights include a pair of damper weights disposed between an axis extending in the tracking direction near the objective lens and the front end of the lens holder.

15. The information recording and reproducing apparatus according to claim 14, wherein the damper weights further include a damper weight provided on a rear end face of the lens holder.

16. The information recording and reproducing apparatus according to claim 10, wherein the damper weights are bonded with a highly viscous adhesive.

17. The information recording and reproducing apparatus according to claim 10, wherein the damper weights are formed of a nonmagnetic metal.

18. The information recording and reproducing apparatus according to claim 10, wherein the ratio of the sum of weights of the damper weights to the total weight of a moving unit of the objective-lens actuator is within the range of 3% to 15%.
